(19) United States
(12) Patent Application Publication
(10) Pub. No.: US 2026/0164383 A1
(43) Pub. Date: Jun. 11, 2026

(54) SYNCHRONIZED INVOCATION OF AN ACTION ON MULTIPLE DEVICES

(71) Applicant: Motorola Mobility LLC, Chicago, IL (US)

(72) Inventors: Amit Kumar Agrawal, Bangalore (IN); Krishnan Raghavan, Bangalore (IN); Nakul Patel, Bangalore (IN)

(73) Assignee: Motorola Mobility LLC, Chicago, IL (US)

(21) Appl. No.: 18/975,082

(22) Filed: Dec. 10, 2024

(51) Int. Cl. H04W 56/00; H04W 64/00

(52) U.S. Cl. CPC H04W 56/002; H04W 64/00

(57) ABSTRACT

In aspects of synchronized invocation of an action on multiple devices, a mobile device implements a synchronization manager that detects an additional mobile device that is located within a threshold distance of the mobile device and that satisfies one or more criteria for synchronization of one or more actions with the mobile device. The mobile device invokes an action, and the synchronization manager receives consent from the additional mobile device to invoke the action. Based at least in part on receiving the consent, the synchronization manager sends a trigger to invoke the action using the additional mobile device.

### BACKGROUND

A variety of applications are available that facilitate group activities for users of multiple mobile devices. For example, gaming, entertainment, networking, education, and content generation applications allow multiple users to launch the applications on their respective mobile devices and play a game together or work on a shared task. However, synchronizing usage of the application using the mobile devices results in challenges, as the application may not be downloaded on each of the mobile devices, or some users may not understand which application to launch on their mobile device. Once using the application, some users may not understand how to navigate to a particular functionality used by the group, and users may not use the application at the same pace, leading to unsynchronized activities and user frustration.

### BRIEF DESCRIPTION OF THE DRAWINGS

Implementations of techniques for synchronized invocation of an action on multiple devices are described with reference to the following Figures. The same numbers may be used throughout to reference like features and components shown in the Figures.

FIG. 1 illustrates an example system for synchronized invocation of an action on multiple devices in accordance with one or more implementations as described herein.

FIG. 2 further illustrates an example of synchronized invocation of an action on multiple devices, including detecting an additional mobile device within a threshold distance, in accordance with one or more implementations as described herein.

FIG. 3 further illustrates an example of synchronized invocation of an action on multiple devices, including prompting a user of the additional mobile device for consent to invoke an action, in accordance with one or more implementations as described herein.

FIG. 4 further illustrates an example of synchronized invocation of an action on multiple devices, including prompting the additional mobile device to download an application to invoke the action, in accordance with one or more implementations as described herein.

FIG. 5 further illustrates an example of synchronized invocation of an action on multiple devices, including sending a trigger to invoke the action using the additional mobile device, in accordance with one or more implementations as described herein.

FIG. 6 further illustrates an example of synchronized invocation of an action on multiple devices, including monitoring the additional mobile device, in accordance with one or more implementations as described herein.

FIG. 7 further illustrates an example of synchronized invocation of an action on multiple devices, triggered by scanning a scannable code using the mobile device, in accordance with one or more implementations as described herein.

FIG. 8 further illustrates an example of synchronized invocation of an action on multiple devices, including prompting a user of the additional mobile device for consent to invoke an action to visit a webpage related to the scannable code, in accordance with one or more implementations as described herein.

FIG. 9 is a flowchart illustrating an example of synchronized invocation of an action on multiple devices in accordance with one or more implementations as described herein.

FIG. 10 illustrates an example method for synchronized invocation of an action on multiple devices in accordance with one or more implementations of the techniques described herein.

FIG. 11 illustrates an example method for synchronized invocation of an action on multiple devices in accordance with one or more implementations of the techniques described herein.

FIG. 12 illustrates an example method for synchronized invocation of an action on multiple devices in accordance with one or more implementations of the techniques described herein.

FIG. 13 illustrates various components of an example device that may be used to implement the techniques for synchronized invocation of an action on multiple devices in accordance with one or more implementations as described herein.

### DETAILED DESCRIPTION

Implementations of the techniques for synchronized invocation of an action on multiple devices may be implemented as described herein. A mobile device and an additional mobile device, such as any type of mobile phone or computing device, may be configured to perform the techniques for synchronized invocation of an action on multiple devices. In one or more implementations, a synchronization manager, housed in the mobile device, the additional mobile device, a central computing device, or a network-based cloud accessible to the mobile device and the additional mobile device, can be used to implement aspects of the techniques described herein.

Mobile devices may launch applications and access webpages related to group activities. For example, gaming applications allow users of multiple mobile devices to play games together, while entertainment, networking, education, and content generation applications allow multiple users to consume entertainment together or collaborate on a task simultaneously. Additionally, a multitude of webpages are available for access using the mobile devices, which may further support group activities, either as a function of the webpage, or by viewing the webpage from the multiple devices.

However, while the applications and webpages may facilitate multiple group activities, some disadvantages are evident related to utilizing the applications and web pages on multiple devices. For example, an application may not be downloaded on each of the multiple devices, preventing simultaneous launch of the application on the multiple devices. Some users may not understand which application to launch, which webpage to access, or how to navigate the application or webpage using their mobile device, which causes frustration among users and delays in collaboration. Additionally, the users may not perform the group activity using the application or the webpage at the same pace, leading to unsynchronized activities and further user frustration.

Techniques and systems are described for synchronized invocation of an action on multiple devices that overcome these limitations. To begin, the synchronization manager detects that the mobile device and the additional mobile device are “co-located,” or physically located within a threshold distance of each other. To do this, the synchronization manager compares GPS data received from the mobile device and the additional mobile device to determine a physical distance between the mobile devices. Additionally, in some implementations the synchronization manager determines that the additional mobile device satisfies criteria for synchronization of actions with the mobile device, such as being identified as part of a group of related devices. For example, the mobile device and the additional mobile device belong to family members or members of a group.

The synchronization manager also monitors for a trigger indicating that the mobile device has invoked an action that involves a group activity. The action, for instance, involves launching an application or visiting a webpage intended for collaboration among multiple devices. In one example implementation, the synchronization manager may detect that an application has been initiated on the mobile device and determine that a type of the application indicates a group activity is intended, such as any type of gaming application, or other application involving input from multiple users. In another example implementation, the synchronization manager may detect that an application has been initiated on the mobile device and also detect that speech data received from the microphone of the mobile device indicates a verbal cue that the application involves a group activity, such as “Let's play a game on this app.” To do this, the synchronization manager may leverage a machine learning model trained to perform voice recognition for users with known associations to the mobile device and the additional mobile device.

After identifying the trigger to invoke the action on the mobile device, the synchronization manager identifies consent from a user of the additional mobile device to invoke the action on the additional mobile device. In one example implementation, the synchronization manager identifies the consent based on received speech data from the microphone of the additional mobile device, such as a vocal reply indicating agreement to the earlier suggestion to play a game together using the application. In situations when the user of the additional mobile device remains silent, the synchronization manager may cause display of a prompt on a display of the additional mobile device, asking the user of the additional mobile device to confirm the consent to the invocation of the action to sync with the mobile device.

After receiving the consent from the user of the additional mobile device, the synchronization manager invokes the action on the additional mobile device, such as launching the application or navigating to the webpage. In some example implementations, the synchronization manager determines that the application is not downloaded on the additional mobile device. In response, the synchronization manager causes display of a prompt to download the application on the additional user device. Because both the mobile device and the additional mobile device now have access to the application or the webpage, collaboration may begin.

Many applications and webpages have different pages that offer different functionalities. To ensure the mobile device and the additional mobile device are accessing the same page, the synchronization manager may monitor further action on the mobile device and the additional mobile device to synchronize the accessed pages. For instance, the synchronization manager navigates the application launched on the additional mobile device to a specific page to match a page open on the mobile device. In other example implementations, the synchronization manager may fast forward or slow down display of video content related to the invocation of the action on the mobile device or the additional mobile device to establish synchronization of consumption of media across the mobile devices.

The described techniques for synchronized invocation of an action on multiple devices overcome the limitations of conventional systems. For example, detecting an additional mobile device within a threshold distance of the mobile device and receiving consent from the additional mobile device to invoke an action results in automatic invocation of the action on multiple devices without manually inviting mobile devices to invoke the action. Synchronized invocation of an action on multiple devices also alleviates user frustration by facilitating downloading and launching of applications and/or webpages to ensure resources are available to invoke the action on multiple devices. Additionally, synchronized invocation of an action on multiple devices promotes efficiency of user collaboration by monitoring the invocation of the action and managing which pages of the application or webpage are actively displayed on the mobile devices to synchronize continued usage of the application or webpage across the mobile devices.

While features and concepts of the described techniques for synchronized invocation of an action on multiple devices is implemented in any number of different devices, systems, environments, and/or configurations, implementations of the techniques for synchronized invocation of an action on multiple devices are described in the context of the following example devices, systems, and methods.

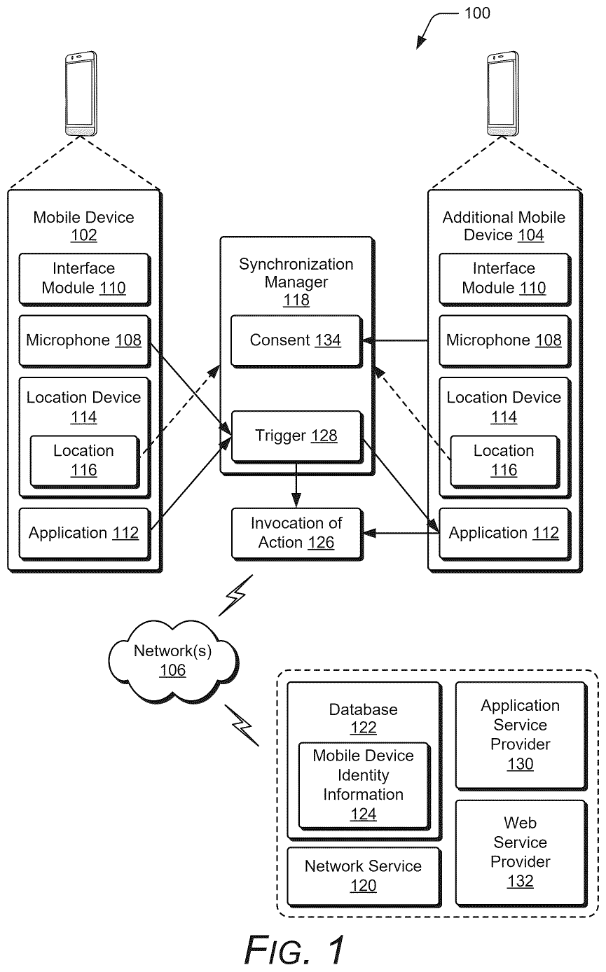

FIG. 1 illustrates an example system 100 for synchronized invocation of an action on multiple devices. The system 100 includes a mobile device 102, an additional mobile device 104, and a communication network 106. Examples of the mobile device 102 and the additional mobile device 104 include at least one of any type of a wireless device, mobile device, mobile phone, flip phone, client device, companion device, tablet, computing device, communication device, entertainment device, gaming device, media playback device, any other type of computing and/or electronic device.

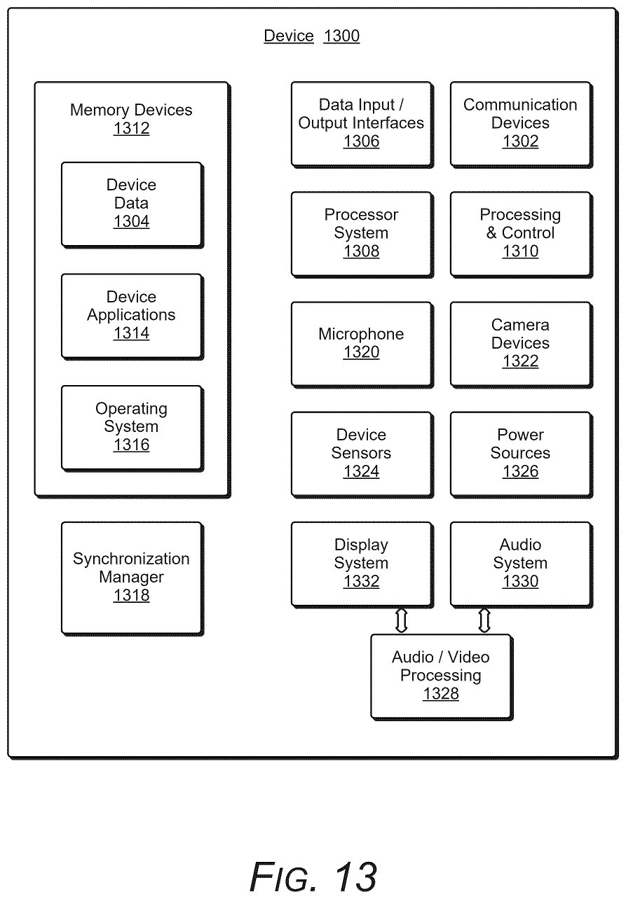

The mobile device 102 and the additional mobile device 104 can be implemented with various components, such as a processor system and memory, as well as any number and combination of different components as further described with reference to the example device shown in FIG. 13. In implementations, the mobile device 102 and the additional mobile device 104 are equipped with a microphone 108 to receive audio data at the mobile device 102 and the additional mobile device 104. The audio data, for instance, may be spoken dialog in the environment of the mobile device 102 or the additional mobile device 104.

In some implementations, the devices, applications, modules, servers, and/or services described herein communicate via the communication network 106, such as for data communication with the mobile device 102 and the additional mobile device 104. The interface module 110 includes a wired and/or a wireless network. The interface module 110 is implemented using any type of network topology and/or communication protocol and is represented or otherwise implemented as a combination of two or more networks, to include IP based networks, cellular networks, and/or the Internet. The communication network 106 includes mobile operator networks that are managed by a mobile network operator and/or other network operators, such as a communication service provider, mobile phone provider, and/or Internet service provider.

The mobile device 102 and the additional mobile device 104 include various functionalities that enable the devices to implement different aspects of synchronized invocation of an action on multiple devices, as described herein. In one or more examples, an interface module 110 represents functionality (e.g., logic and/or hardware) enabling the mobile device 102 and the additional mobile device 104 to interconnect and interface with other devices and/or networks, such as the communication network 106. For example, the interface module 110 enables wireless and/or wired connectivity of the mobile device 102 and the additional mobile device 104.

The mobile device 102 and the additional mobile device 104 can include and implement an application 112, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the mobile device 102 or the additional mobile device 104. Generally, an application user interface, or any other type of video, image, graphic, and the like is digital image content that is displayable on the display screen of the mobile device 102 and the additional mobile device 104. The application 112 may be accessible to the mobile device 102 and the additional mobile device 104 from an application service provider 130 via the communication network 106.

In implementations, the mobile device 102 and the additional mobile device 104 may include any type of location device 114, such as a GPS transceiver or other type of geo-location device, to determine a location 116 of the mobile device 102 and the additional mobile device 104. Notably, any of the devices described herein, to include components, modules, services, computing devices, camera devices, and/or the tracking tags, can share the GPS data between any of the devices, whether they are GPS-hardware enabled or not. Additionally or alternatively, the mobile device 102 and the additional mobile device 104 can also include various radios for wireless communication in the environment, such as a UWB radio, Bluetooth radio, or a Wi-Fi radio implemented for wireless communications with the other devices in the environment.

In the example system 100 for synchronized invocation of an action on multiple devices, the mobile device 102 and/or the additional mobile device 104 implements a synchronization manager 118. For example, the synchronization manager 118 may be implemented using a network service 120, such as a cloud-based service, in communication with the mobile device 102 and the additional mobile device 104 via the communication network 106. Additionally or alternatively, the synchronization manager 118 is implemented in an external device in communication with the mobile device 102 and the additional mobile device 104 via the communication network 106. As shown in this example, the synchronization manager 118 represents functionality (e.g., logic, software, and/or hardware) enabling aspects of the described techniques for synchronized invocation of an action on multiple devices. The synchronization manager 118 can be implemented as computer instructions stored on computer-readable storage media and can be executed by a processor system of the mobile device 102 and/or the additional mobile device 104. Alternatively, or in addition, the synchronization manager 118 can be implemented at least partially in hardware of the device.

In one or more implementations, the synchronization manager 118 includes independent processing, memory, and/or logic components functioning as a computing and/or electronic device integrated with the mobile device 102 and/or the additional mobile device 104. Alternatively, or in addition, the synchronization manager 118 can be implemented in software, in hardware, or as a combination of software and hardware components. In this example, the synchronization manager 118 is implemented as a software application or module, such as executable software instructions (e.g., computer-executable instructions) that are executable with a processor system of the mobile device 102 and/or the additional mobile device 104 to implement the techniques and features described herein. As a software application or module, the synchronization manager 118 can be stored on computer-readable storage memory (e.g., memory of a device), or in any other suitable memory device or electronic data storage implemented with the controller. Alternatively or in addition, the synchronization manager 118 is implemented in firmware and/or at least partially in computer hardware. For example, at least part of the synchronization manager 118 is executable by a computer processor, and/or at least part of the content manager is implemented in logic circuitry.

In this example system 100, the synchronization manager 118 synchronizes an invocation of an action 126 between the mobile device 102 and the additional mobile device 104. For instance, the synchronization manager 118 detects invocation of the action 126 on the mobile device 102, such as launching an application 112, navigating to a webpage, or any other action, and automatically coordinates synchronization of the additional mobile device 104 to invoke the action 126.

To do this, the synchronization manager 118 determines that the mobile device 102 and the additional mobile device 104 are physically located within a threshold distance of each other (i.e., are co-located). To do this, the synchronization manager 118 leverages the location device 114 to determine the location 116 of the mobile device 102 and the additional mobile device 104. For example, the location device 114 is a GPS device, and the synchronization manager 118 determines the location 116 based on GPS data. Additionally or alternatively, the location device 114 involves a UWB tag incorporated in the mobile device 102 and the additional mobile device 104, and the synchronization manager 118 determines the mobile device 102 is within the threshold distance by comparing the signal path loss from received signals from the UWB tags. In some implementations, the synchronization manager 118 accesses a database 122 via the communication network 106 that includes mobile device identity information 124.

Additionally, in some implementations the synchronization manager 118 determines that the additional mobile device 104 satisfies criteria for synchronization of actions with the mobile device 102, such as being part of a pre-assigned group of devices. For example, the mobile device 102 and the additional mobile device 104 belong to family members or members of a group.

The synchronization manager 118 also monitors for a trigger 128 indicating that the mobile device 102 has invoked an action 126 that involves a group activity or group collaboration. In one example implementation, the synchronization manager 118 may detect that an application 112 has been initiated on the mobile device 102 and determine that the application 112 involves a group activity, such as any type of gaming application, collaboration application, scheduling application, or other type of application involving input from multiple users. In another example implementation, the synchronization manager 118 may detect that an application 112 has been initiated on the mobile device 102 and also receive speech data from the microphone 108 indicating that the application 112 involves a group activity, such as “Let's play this game.” The application 112, for instance, may be accessible to the mobile device 102 and the additional mobile device 104 from an application service provider 130 via the communication network 106. Similarly, the webpage may be accessible to the mobile device 102 and the additional mobile device 104 from a web service provider 132 via the communication network 106.

After identifying the trigger 128 to invoke the action 126 on the mobile device 102, the synchronization manager 118 identifies consent 134 from a user of the additional mobile device 104 to invoke the action 126 on the additional mobile device 104. In one example implementation, the synchronization manager 118 identifies the consent 134 based on received speech data from the microphone 108 of the additional mobile device 104, such as a vocal reply indicating agreement to the earlier suggestion to play a game together using the application 112. In situations when the user of the additional mobile device 104 remains silent, the synchronization manager 118 may cause display of a prompt on a display of the additional mobile device 104, asking the user of the additional mobile device 104 to confirm the consent 134 to the invocation of the action 126 to sync with the mobile device 102.

After receiving the consent 134 from the user of the additional mobile device 104, the synchronization manager 118 invokes the action 126 on the additional mobile device 104, such as launching the application 112 or webpage already launched on the mobile device 102. The synchronization manager 118 may do this by transmitting a deep link or broadcast ID to the additional mobile device 104. Additionally, in some implementations, the synchronization manager 118 monitors further action on the mobile device 102 and the additional mobile device 104 to synchronize stages or other aspects related to the application 112 or the webpage on the mobile device 102 and the additional mobile device 104. For instance, the synchronization manager 118 navigates the application 112 launched on the additional mobile device 104 to a specific page to match a page open on the mobile device 102.

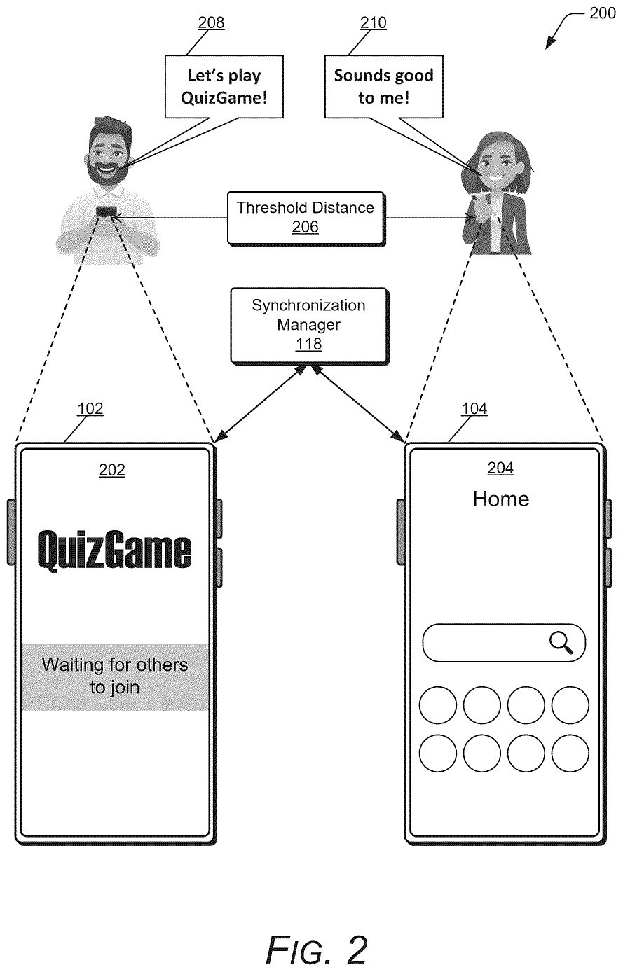

FIG. 2 illustrates an example 200 of synchronized invocation of an action on multiple devices, including detecting an additional mobile device within a threshold distance, as described herein. In the example 200, a synchronization manager 118 configured for synchronized invocation of an action on multiple devices is implemented in a mobile device 102, an additional mobile device 104, or in another device or network-based cloud that is in communication with the mobile device 102 and the additional mobile device 104. The mobile device 102 and the additional mobile device 104 are configured to display content accessed from the mobile device 102 and the additional mobile device 104, such as application and webpage user interfaces. For instance, the mobile device 102 includes a display featuring a user interface 202, and the additional mobile device 104 includes an additional display featuring an additional user interface.

As illustrated in this example, the synchronization manager 118 determines that the mobile device 102 and the additional mobile device 104 are physically within a threshold distance 206 of each other. To do this, the synchronization manager 118 receives location data from the location device 114 of the mobile device 102 and the additional mobile device 104 and compares the location data to determine whether the mobile device 102 and the additional mobile device 104 are located within the threshold distance 206. For example, the location device 114 is a GPS device, and the synchronization manager 118 determines the location 116 based on GPS data. Additionally or alternatively, the location device 114 involves a UWB tag incorporated in the mobile device 102 and the additional mobile device 104, and the synchronization manager 118 determines the mobile device 102 is within the threshold distance by comparing the signal path loss from received signals from the UWB tags. In some implementations, the synchronization manager 118 accesses a database 122 via the communication network 106 that includes mobile device identity information 124.

As illustrated in this example, the synchronization manager 118 determines that the mobile device 102 and the additional mobile device 104 are located within the threshold distance 206. In some example implementations, the synchronization manager 118 continuously monitors for co-located devices based on the threshold distance 206. Additionally, in some implementations the synchronization manager 118 determines that the additional mobile device 104 is pre-associated for synchronization of actions with the mobile device 102. In this example, the mobile device 102 and the additional mobile device 104 belong to family members.

The synchronization manager 118 also detects an invocation of an action 126 using the mobile device 102. As illustrated in this example, a trivia application called “QuizGame” is launched on the mobile device 102 and is displayed on in the user interface 202. The synchronization manager 118 determines that the invocation of the action 126 involves a group activity before initiating synchronization with another device. For example, the synchronization manager 118 determines that the “QuizGame” app involves a group activity because it is a game played by multiple users with multiple devices.

Additionally or alternatively, the synchronization manager 118 determines that the invocation of the action 126 involves a group activity based on received audio data from the mobile device 102. As illustrated in this example, the user of the mobile device 102 says trigger dialog 208 “Let's play QuizGame!” The synchronization manager 118 determines that because this speech is directed at another user, then the invocation of the action 126 involving the launching of the application is intended to involve a group activity and therefore synchronized with other devices. Although this example involves the synchronization manager 118 determining the mobile device 102 and the additional mobile device 104 are located within the threshold distance 206 before determining that the invocation of the action 126 involves a group activity, it is noted that these steps may be performed in any order.

The synchronization manager 118 also determines whether the user of the synchronization manager 118 consents to invoke the action using the additional mobile device 104. For example, the synchronization manager 118 may identify the consent 134 based on received speech data from the microphone 108 of the additional mobile device 104, such as a vocal reply. As illustrated in this example, the synchronization manager 118 detects that the user of the additional mobile device 104 says consent dialog 210 “Sounds good to me!” in response to the suggestion of from the user of the mobile device 102 to play “QuizGame.” For instance, the synchronization manager 118 monitors audio data collected from a microphone 108 of the mobile device 102 and/or the additional mobile device 104 to determine whether the user of the additional mobile device 104 consents to the invocation of the action 126. Further, in some example implementations, the synchronization manager 118 leverages a voice recognition model, which may involve an algorithm trained to identify user's voices captured in the audio data, to determine whether the user of the additional mobile device 104 consents to the invocation of the action 126.

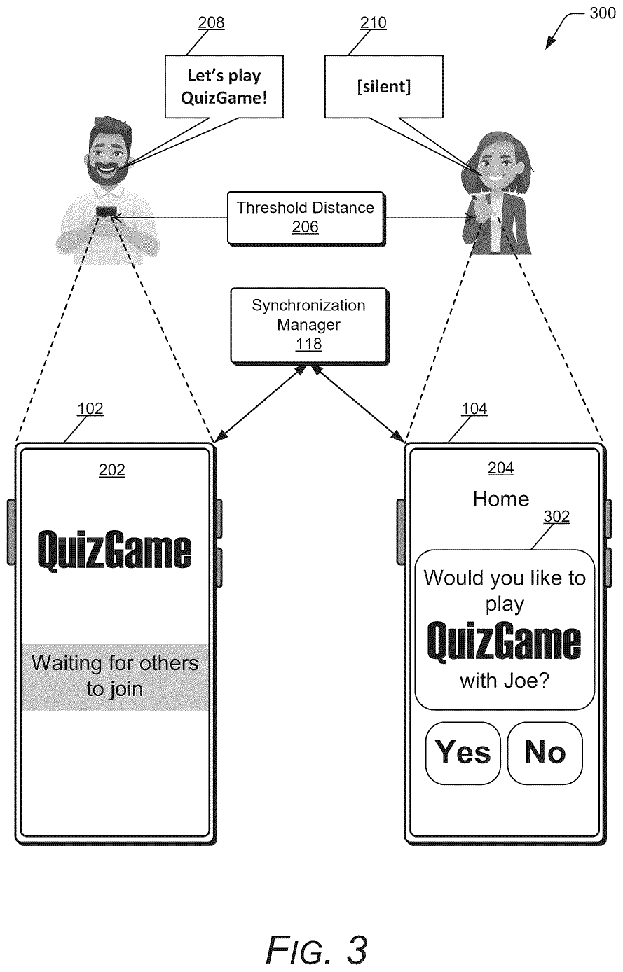

FIG. 3 illustrates an example 300 of synchronized invocation of an action on multiple devices, including prompting a user of the additional mobile device for consent to invoke an action, as described herein. The example 300 is an alternative implementation of the example 200 described with respect to FIG. 2.

As illustrated in this example, the user of the mobile device 102 says trigger dialog 208 “Let's play QuizGame!” The synchronization manager 118 determines that because this speech is directed at another user and that the invocation of the action 126 involving the launching of the application is intended to involve a group activity to be synchronized with other devices.

However, in this example the synchronization manager 118 detects that the user of the additional mobile device 104 is silent regarding the consent dialog 210 in response to the suggestion of from the user of the mobile device 102 to play “QuizGame.” For instance, the synchronization manager 118 monitors audio data collected from a microphone 108 of the mobile device 102 and/or the additional mobile device 104 to determine whether the user of the additional mobile device 104 consents to the invocation of the action 126. Because the synchronization manager 118 is unable to receive the consent 134 from the user of the additional mobile device 104, the synchronization manager 118 generates a consent prompt 302 for display on the user interface 204 of the additional mobile device 104. For example, the consent prompt 302 reads “Would you like to play QuizGame with Joe?” and offers buttons to respond “Yes” or “No.” In this way, the synchronization manager 118 may receive the consent 134 from the user of the additional mobile device 104 even though the consent dialog 210 is silent.

In other example implementations, the consent prompt 302 may be a verbal or audio prompt. For example, the synchronization manager 118 causes output of audio from a speaker device of the additional mobile device 104 that says “Would you like to place QuizGame with Joe?” and monitors to detect a response from the user of the additional mobile device 104 to confirm consent 134.

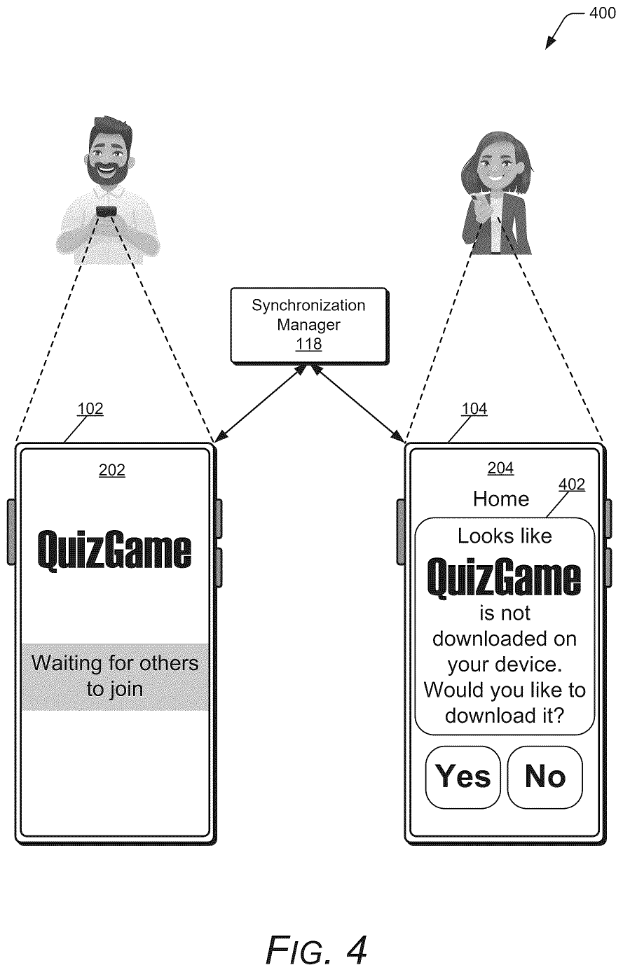

FIG. 4 illustrates an example 400 of synchronized invocation of an action on multiple devices, including prompting the additional mobile device to download an application to invoke the action, as described herein. The example 400 is a continuation of the example 200 described with respect to FIG. 2 or the example 300 described with respect to FIG. 3.

In the example 400, the synchronization manager 118 has received the consent 134 from the user of the additional mobile device 104 to invoke the action 126 using the additional mobile device 104. However, the application 112 involved in the invocation of the action 126 using the mobile device 102 is not installed on the additional mobile device 104. The synchronization manager 118 detects that the application 112 is not installed on the additional mobile device 104 and generates a download prompt 402 requesting the user of the additional mobile device 104 to download or to allow download of the application 112.

In this example, the download prompt 402 says “Looks like QuizGame is not downloaded on your device. Would you like to download it?” and offers buttons to respond “Yes” or “No.” If the user of the additional mobile device 104 responds with “Yes,” an automatic download of the application 112 may commence. In other example implementations, the user of the additional mobile device 104 is instructed to manually download the application 112. Further, in other example implementations, the synchronization manager 118 automatically causes download of the application 112 on the additional mobile device 104 without receiving download consent from the user of the additional mobile device 104.

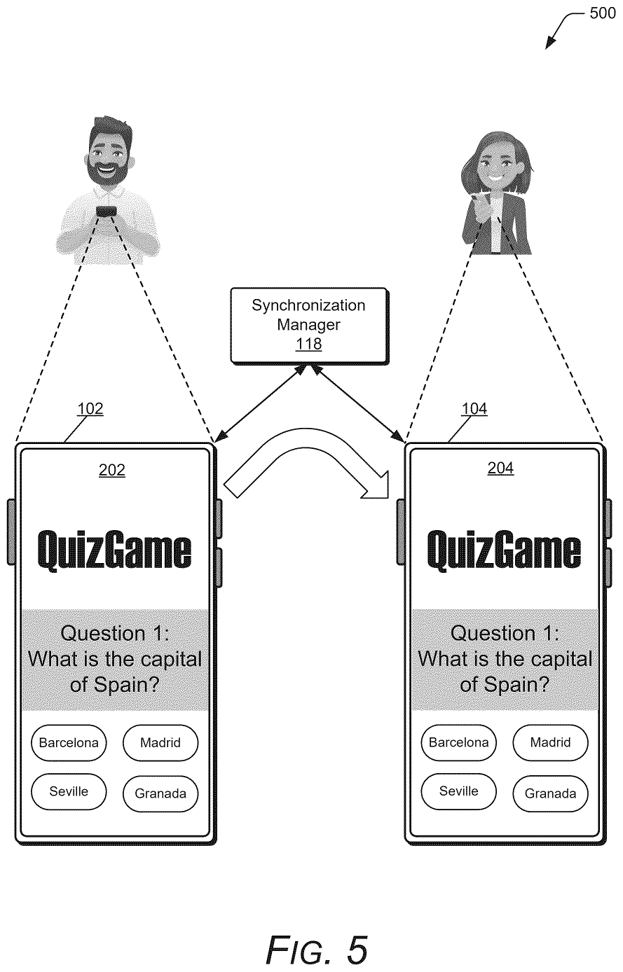

FIG. 5 illustrates an example 500 of synchronized invocation of an action on multiple devices, including sending a trigger to invoke the action using the additional mobile device, as described herein. The example 500 is a continuation of the example 400 described with respect to FIG. 4.

In the example 500, the synchronization manager 118 has received consent 134 from the user of the additional mobile device 104 to invoke the action 126 using the additional mobile device 104. In this example, the invocation of the action 126 involves launching the application 112 called “QuizGime.” Therefore, to synchronize the invocation of the action 126 on the mobile device 102 with the additional mobile device 104, the synchronization manager 118 launches the application 112 on the additional mobile device 104, which is now downloaded. As illustrated in this example, the “QuizGame” application is launched on the additional mobile device 104 so that the user of the additional mobile device 104 and user of the mobile device 102 may simultaneously use the application.

In other example implementations, the invocation of the action 126 involves navigating to a webpage using the mobile device 102. In this situation, to synchronize the invocation of the action 126 on the mobile device 102 with the additional mobile device 104, the synchronization manager 118 navigates to the webpage using the additional mobile device 104 so that the user of the additional mobile device 104 and user of the mobile device 102 may simultaneously interact with content on the webpage.

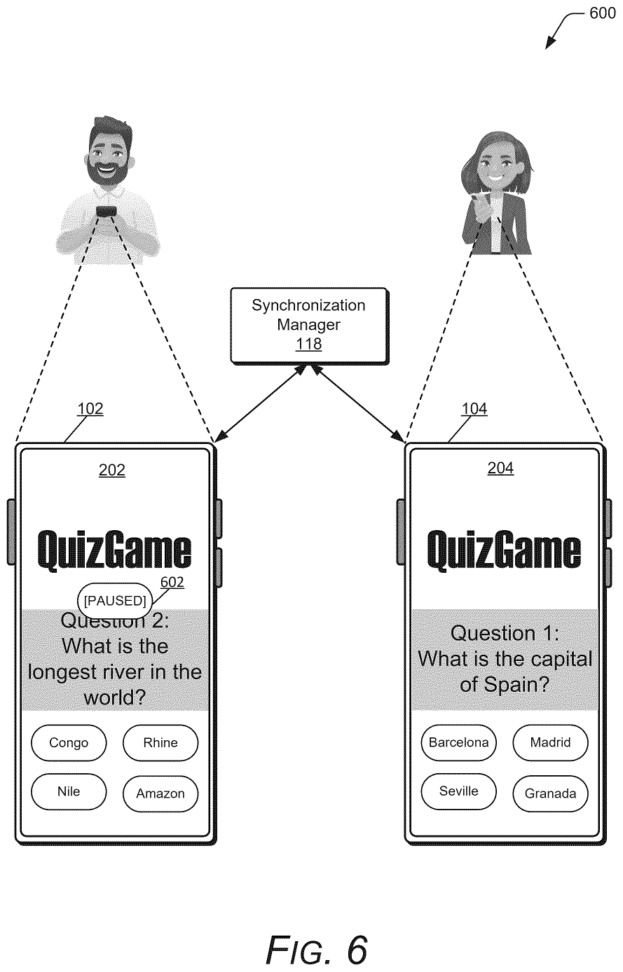

FIG. 6 illustrates an example 600 of synchronized invocation of an action on multiple devices, including monitoring the additional mobile device, as described herein. The example 600 is a continuation of the example 500 described with respect to FIG. 5.

In the example 600, after invoking the action 126 using the additional mobile device 104, the synchronization manager 118 monitors the mobile device 102 and the additional mobile device 104 to synchronize the action 126 on the mobile device 102 and the additional mobile device 104. As shown in this example, the application “QuizGame” has been launched on both the mobile device 102 and the additional mobile device 104. This initiates a series of trivia questions displayed on the user interface 202 of the mobile device 102 and the user interface 204 of the additional mobile device 104, beginning at a first question on a starting page. However, the user of the additional mobile device 104 has already navigated past the starting page by answering the first question, while the user of the additional mobile device 104 has not yet answered the first question.

To synchronize the action 126 on the mobile device 102 with the additional mobile device 104, the synchronization manager 118 causes a pause 602 to navigation or interaction with the application 112 on the mobile device 102 so that the mobile device 102 remains on at a stopping page until the additional mobile device 104 navigates to the stopping page. As illustrated, the synchronization manager 118 causes the “QuizGame” application to pause at Question 2 on the mobile device 102 until the additional mobile device 104 navigates to Question 2 by the user of the additional mobile device 104 answering the first question. The synchronization manager 118 then continues to further monitor the stages of the mobile device 102 and the additional mobile device 104 so that the mobile device 102 and the additional mobile device 104 remain synchronized.

In some example implementations, the synchronization manager 118 causes the additional mobile device 104 to skip pages of the application 112 or webpage to catch up to a page of the application 112 or webpage being viewed on the mobile device 102. For example, the user of the mobile device 102 skips an account setup page, prompting the synchronization manager 118 to skip display of the account setup page on the additional mobile device 104.

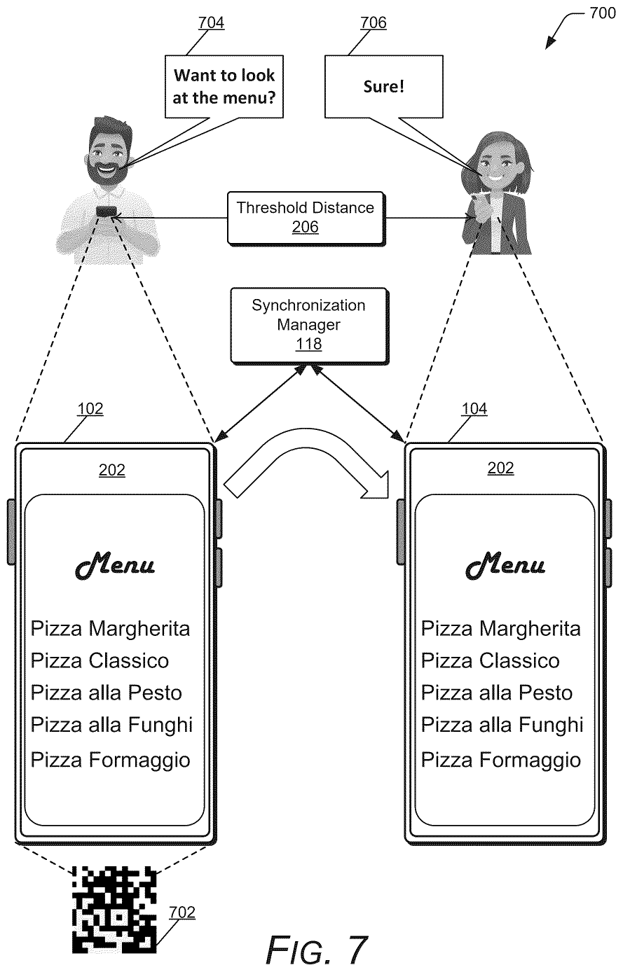

FIG. 7 illustrates an example 700 of synchronized invocation of an action on multiple devices, including monitoring the additional mobile device, as described herein. The example 700 is an alternative implementation of the example 200 described with respect to FIG. 2. The example 700, for instance, involves an invocation of an action involving accessing a webpage using a Quick Response (QR) code, rather than launching an application.

In the example 700 a synchronization manager 118 configured for synchronized invocation of an action on multiple devices is implemented in a mobile device 102, an additional mobile device 104, or in another device or cloud that is in communication with the mobile device 102 and the additional mobile device 104. The mobile device 102 and the additional mobile device 104 are configured to display content accessed from the mobile device 102 and the additional mobile device 104, such as a webpage. For instance, the mobile device 102 includes a display featuring a user interface 202, and the additional mobile device 104 includes an additional display featuring an additional user interface.

As illustrated in this example, the synchronization manager 118 determines that the mobile device 102 and the additional mobile device 104 are within a threshold distance 206. To do this, the synchronization manager 118 leverages the location device 114 to determine the location 116 of the mobile device 102 and the additional mobile device 104. For example, the location device 114 is a GPS device, and the synchronization manager 118 determines the location 116 based on GPS data. Additionally or alternatively, the location device 114 involves a UWB tag incorporated in the mobile device 102 and the additional mobile device 104, and the synchronization manager 118 determines the mobile device 102 is within the threshold distance by comparing the signal path loss from received signals from the UWB tags. In some implementations, the synchronization manager 118 accesses a database 122 via the communication network 106 that includes mobile device identity information 124.

For example, the mobile device 102 and the additional mobile device 104 may include any type of location device 114, such as a GPS transceiver or other type of geo-location device, to determine a location 116 of the mobile device 102 and the additional mobile device 104.

As illustrated in this example, the synchronization manager 118 determines that the mobile device 102 and the additional mobile device 104 are located within the threshold distance 206. In some example implementations, the synchronization manager 118 continuously monitors for co-located devices based on the threshold distance 206.

The synchronization manager 118 also detects an invocation of an action 126 using the mobile device 102. As illustrated in this example, a menu at a restaurant is accessed on the mobile device 102 by navigating to a webpage featuring the menu by scanning a QR code 702 with a camera device of the mobile device 102, and the menu is displayed on in the user interface 202. The synchronization manager 118 determines that the invocation of the action 126 involves a group activity before initiating synchronization with another device. For example, the synchronization manager 118 determines that a shared calendar event includes the user of the mobile device 102 and the user of the additional mobile device 104 dining at the restaurant together. In other example implementations, the synchronization manager 118 determines the mobile device 102 and the user of the additional mobile device 104 are already linked and/or using a group application.

Additionally or alternatively, the synchronization manager 118 determines that the invocation of the action 126 involves a group activity based on received audio data from the mobile device 102. As illustrated in this example, the user of the mobile device 102 says trigger dialog 704 “Want to look at the menu?” The synchronization manager 118 determines that because this speech is directed at another user, then the invocation of the action 126 involving navigating to the webpage featuring the menu is intended to involve a group activity and therefore synchronized with other devices. Although this example involves the synchronization manager 118 determining the mobile device 102 and the additional mobile device 104 are located within the threshold distance 206 before determining that the invocation of the action 126 involves a group activity, it is noted that these steps may be performed in any order.

The synchronization manager 118 also determines whether the user of the synchronization manager 118 consents to invoke the action using the additional mobile device 104. For example, the synchronization manager 118 may identify the consent 134 based on received speech data from the microphone 108 of the additional mobile device 104, such as a vocal reply. As illustrated in this example, the synchronization manager 118 detects that the user of the additional mobile device 104 says consent dialog 706 “Sure!” in response to the suggestion of from the user of the mobile device 102 to view the menu For instance, the synchronization manager 118 monitors audio data collected from a microphone 108 of the mobile device 102 and/or the additional mobile device 104 to determine whether the user of the additional mobile device 104 consents to the invocation of the action 126. Further, in some example implementations, the synchronization manager 118 leverages a voice recognition model, which may involve an algorithm trained to identify user's voices captured in the audio data, to determine whether the user of the additional mobile device 104 consents to the invocation of the action 126.

In response to receiving the consent 134 to invoke the action 126 using the additional mobile device 104, the synchronization manager 118 causes invocation of the action 126 using the additional mobile device 104. In this example, the synchronization manager 118 causes the additional mobile device 104 to navigate to the webpage featuring the menu, so that the user of the additional mobile device 104 may avoid manually scanning the QR code.

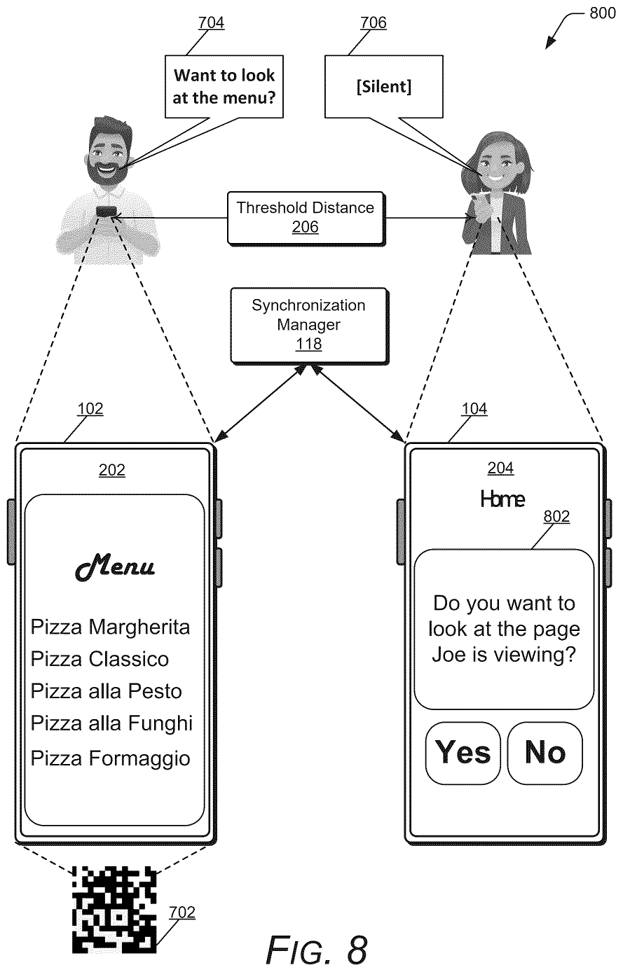

FIG. 8 illustrates an example 800 of synchronized invocation of an action on multiple devices, including prompting a user of the additional mobile device for consent to invoke an action to visit a webpage related to the scannable code, as described herein. The example 800 is an alternative implementation of the example 700 described with respect to FIG. 7.

In the example 800, the user of the mobile device 102 says trigger dialog 704 “Want to look at the menu?” The synchronization manager 118 determines that because this speech is directed at another user, then the invocation of the action 126 involving the navigation to the webpage is intended involve a group activity and therefore synchronized with other devices.

However, in this example the synchronization manager 118 detects that the user of the additional mobile device 104 is silent regarding the consent dialog 706 in response to the suggestion of from the user of the mobile device 102 to look at the menu. For instance, the synchronization manager 118 monitors audio data collected from a microphone 108 of the mobile device 102 and/or the additional mobile device 104 to determine whether the user of the additional mobile device 104 consents to the invocation of the action 126. Because the synchronization manager 118 is unable to receive the consent 134 from the user of the additional mobile device 104, the synchronization manager 118 generates a consent prompt 802 for display on the user interface 204 of the additional mobile device 104. For example, the consent prompt 302 reads “Do you want to look at the page Joe is viewing?” and offers buttons to respond “Yes” or “No.” In this way, the synchronization manager 118 may receive the consent 134 from the user of the additional mobile device 104 even though the consent dialog 210 is silent.

In other example implementations, the consent prompt 302 may be a verbal or audio prompt. For example, the synchronization manager 118 causes output of audio from a speaker device of the additional mobile device 104 that says “Do you want to look at the page Joe is viewing?” and monitors to detect a response from the user of the additional mobile device 104 to confirm consent 134.

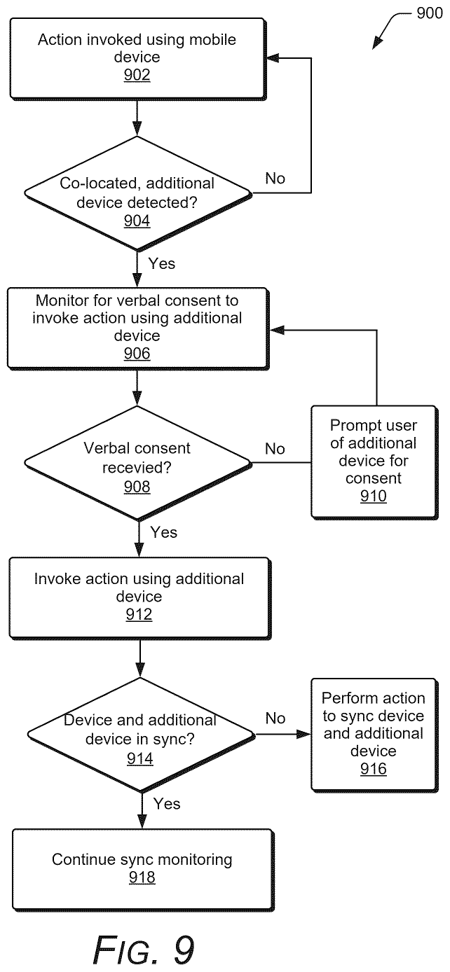

FIG. 9 is a flowchart 900 illustrating an example of synchronized invocation of an action on multiple devices in accordance with one or more implementations, as described herein.

At 902, an action 126 is invoked using a mobile device 102. A synchronization manager 118 determines, at 904, whether the mobile device 102 is co-located with an additional mobile device 104. For example, the synchronization manager 118 determines whether the mobile device 102 and the additional mobile device 104 are located within a threshold distance based on location data, calendar data, or other location-specifying data from the mobile device 102 and the additional mobile device 104 or associated with the users of the devices. If the additional mobile device 104 is not co-located with the mobile device 102, the synchronization manager 118 continues to monitor whether the mobile device 102 is co-located with an additional mobile device 104.

At 906, the synchronization manager 118 monitors for verbal consent to invoke the action 126 using the additional mobile device 104. For example, the synchronization manager 118 monitors audio data captured using one or more microphones associated with the additional mobile device 104 to detect the verbal consent. If verbal consent is received, at 908, the synchronization manager 118 invokes the action 126 using the additional mobile device 104. If verbal consent is not received, at 910, the synchronization manager 118 causes generation of a prompt for display on the additional mobile device 104 to prompt the user of the additional mobile device 104 for consent.

After invoking the action 126 using the additional mobile device 104 at 912, the synchronization manager 118, at 914, determines whether the mobile device 102 and the additional mobile device 104 are in sync. If the mobile device 102 and the additional mobile device 104 are not in sync, at 916, the synchronization manager 118 performs an action to sync the mobile device 102 and the additional mobile device 104. For example, the synchronization manager 118 may pause display of content on the mobile device 102 and/or skip display of content on the additional mobile device 104. If the mobile device 102 and the additional mobile device 104 are in sync, the synchronization manager 118 continues to monitor, at 918, whether the mobile device 102 and the additional mobile device 104 are in sync.

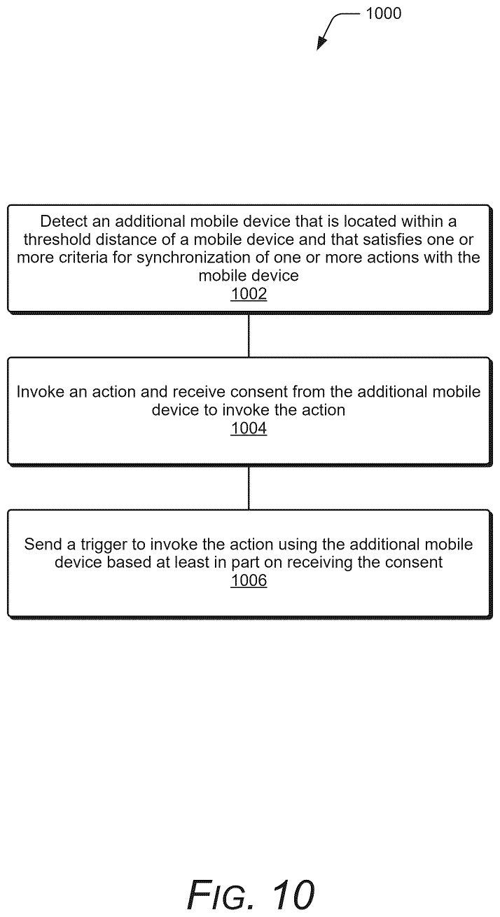

Example methods 1000, 1100, and 1200 are described with reference to respective FIGS. 10, 11, and 12 in accordance with one or more implementations of synchronized invocation of an action on multiple devices, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 10 illustrates example method(s) 1000 for synchronized invocation of an action on multiple devices. The order in which the method is described is not intended to be construed as a limitation, and any number or combination of the described method operations may be performed in any order to perform a method, or an alternate method.

At 1002, an additional mobile device is detected that is located within a threshold distance of the mobile device and that satisfies one or more criteria for synchronization of one or more actions with the mobile device. For example, the synchronization manager 118 detects an additional mobile device 104 that is located within a threshold distance 206 of the mobile device 102 and that satisfies one or more criteria for synchronization of one or more actions with the mobile device 102. In this example, the threshold distance 206 is determined based on a determined location for the mobile device 102 and a received indication of a location from the additional mobile device 104. In some examples, the synchronization manager 118 detects the additional mobile device 104 in response to a trigger involving an application 112 being launched on the mobile device 102.

At 1004, an action is invoked, and consent is received from the additional mobile device to invoke the action. For example, the synchronization manager 118 invokes an action 126 and receives consent 134 from the additional mobile device 104 to invoke the action 126. In this example, the consent 134 from the additional mobile device 104 is indicated by verbal consent detected from a user of the additional mobile device 104 using voice recognition. In some examples, the synchronization manager 118 prompts a user of the additional mobile device 104 to indicate the consent to invoke the action 126.

At 1006, a trigger is sent to invoke the action using the additional mobile device based at least in part on receiving the consent. For example, the synchronization manager 118 sends a trigger to invoke the action 126 using the additional mobile device 104 based at least in part on receiving the consent 134. In this example, the action 126 involves transmitting instruction to the additional mobile device 104 to automatically open a webpage using the additional mobile device 104 that is open on the mobile device 102. In some examples, the trigger involves automatically launching an application 112 using the additional mobile device 104 that is launched on the mobile device 102, and the synchronization manager 118 requests information from the additional mobile device 104 indicating whether the application 112 is downloaded on the additional mobile device 104. For example, the synchronization manager 118 transmits a prompt to the additional mobile device 104 to prompt a user of the additional mobile device 104 to download the application 112 on the additional mobile device 104 based on the information from the additional mobile device 104 indicating whether the application 112 is downloaded on the additional mobile device 104. In some examples, the synchronization manager 118 monitors the additional mobile device 104 based on received usage information to determine that content displayed on the mobile device 102 is synchronized with content displayed on the additional mobile device 104.

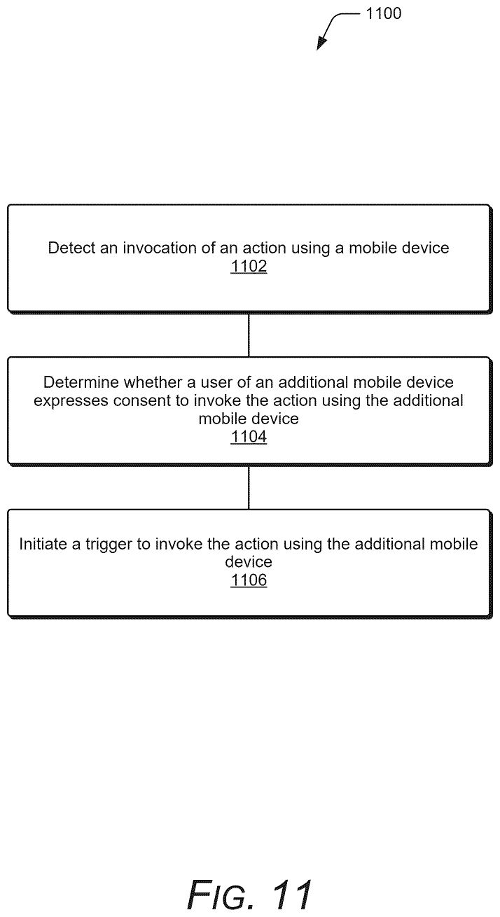

FIG. 11 illustrates example method(s) 1100 for synchronized invocation of an action on multiple devices. The order in which the method is described is not intended to be construed as a limitation, and any number or combination of the described method operations may be performed in any order to perform a method, or an alternate method.

At 1102, an invocation of an action is detected using a mobile device. For example, the synchronization manager 118 detects an invocation of an action 126 using a mobile device 102.

At 1104, whether a user of an additional mobile device expresses consent to invoke the action using the additional mobile device is determined. For example, the synchronization manager 118 determines whether a user of an additional mobile device 104 expresses consent 134 to invoke the action 126 using the additional mobile device 104. In some examples, the synchronization manager 118 determines that the mobile device 102 and the additional mobile device 104 are located within a threshold distance 206 based on a determined location for the mobile device 102 and a determined location for the additional mobile device 104. For example, the consent 134 from the additional mobile device 104 is indicated by verbal consent detected from a user of the additional mobile device 104 using voice recognition.

At 1106, a trigger is initiated to invoke the action using the additional mobile device. For example, the synchronization manager 118 initiates a trigger to invoke the action 126 using the additional mobile device 104. In some examples, the trigger involves automatically opening a webpage using the additional mobile device 104 that is open on the mobile device 102. In other examples, the trigger involves automatically launching an application 112 using the additional mobile device 104 that is launched on the mobile device 102, and further comprising determining whether the application 112 is downloaded on the additional mobile device 104. In some examples, the synchronization manager 118 prompts a user of the additional mobile device 104 to download the application 112 on the additional mobile device 104 based on the determination on whether the application is downloaded on the additional mobile device 104. In some examples, the synchronization manager 118 monitors the mobile device 102 and the additional mobile device 104 to determine that content displayed on the mobile device 102 is synchronized with content displayed on the additional mobile device 104.

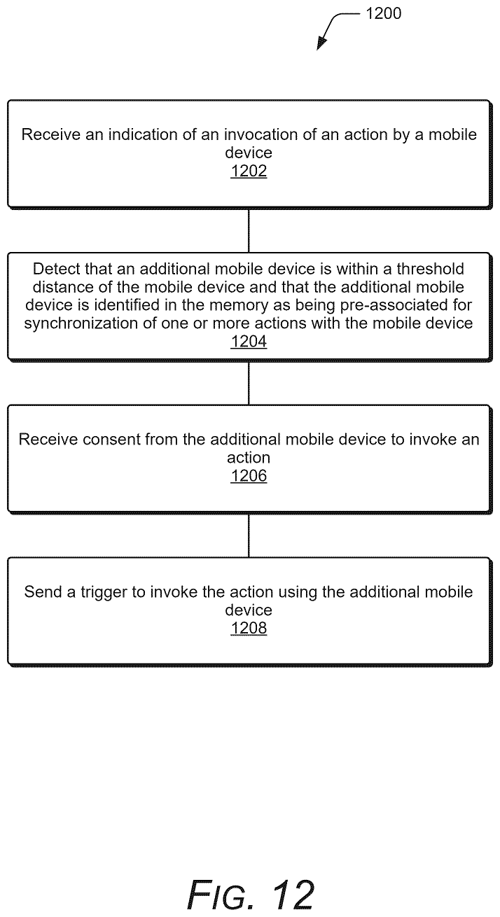

FIG. 12 illustrates example method(s) 1200 for synchronized invocation of an action on multiple devices. The order in which the method is described is not intended to be construed as a limitation, and any number or combination of the described method operations may be performed in any order to perform a method, or an alternate method.

At 1202, an indication of an invocation of an action by a mobile device is received. For example, the synchronization manager 118 receives an indication of an invocation of an action 126 by a mobile device 102.

At 1204, an additional mobile device is detected within a threshold distance of the mobile device and identified in the memory as being pre-associated for synchronization of one or more actions with the mobile device. For example, the synchronization manager 118 detects an additional mobile device 104 within a threshold distance 206 of the mobile device 102 and identified in the memory as being pre-associated for synchronization of one or more actions with the mobile device 102. In this example, the synchronization manager 118 determines the additional mobile device 104 is within the threshold distance 206 of the mobile device 102 based on received calendar data indicating a user of the mobile device 102 and a user of the additional mobile device 104 attending an event.

At 1206, consent is received from the additional mobile device to invoke an action. For example, the synchronization manager 118 receives consent 134 from the additional mobile device 104 to invoke an action 126.

At 1208, a trigger is sent to invoke the action using the additional mobile device. For example, the synchronization manager 118 sends a trigger to invoke the action 126 using the additional mobile device 104. In this example, the trigger involves automatically opening a webpage using the additional mobile device 104 that is open on the mobile device 102. In other examples, the trigger involves automatically launching an application 112 using the additional mobile device 104 that is launched on the mobile device 102, and the synchronization manager 118 prompts a user of the additional mobile device 104 based on received data indicating whether the application 112 is downloaded on the additional mobile device 104.

FIG. 13 illustrates various components of an example device 1300, which can implement aspects of the techniques and features for synchronized invocation of an action on multiple devices, as described herein. The example device 1300 may be implemented as any of the devices described with reference to the previous FIGS. 1-9, such as any type of a wireless device, mobile device, mobile phone, flip phone, client device, companion device, display device, tablet, computing, communication, entertainment, gaming, media playback, and/or any other type of computing, consumer, and/or electronic device. For example, the microphone 108 described with reference to FIGS. 1-12 may be implemented as the example device 1300.

The example device 1300 can include various, different communication devices 1302 that enable wired and/or wireless communication of device data 1304 with other devices. The device data 1304 can include any of the various devices data and content that is generated, processed, determined, received, stored, and/or communicated from one computing device to another. Generally, the device data 1304 can include any form of audio, video, image, graphics, and/or electronic data that is generated by applications executing on a device. The communication devices 1302 can also include transceivers for cellular phone communication and/or for any type of network data communication.

The example device 1300 can also include various, different types of data input/output (I/O) interfaces 1306, such as data network interfaces that provide connection and/or communication links between the devices, data networks, and other devices. The data I/O interfaces 1306 may be used to couple the device to any type of components, peripherals, and/or accessory devices, such as a computer input device that may be integrated with the example device 1300. The I/O interfaces 1306 may also include data input ports via which any type of data, information, media content, communications, messages, and/or inputs may be received, such as user inputs to the device, as well as any type of audio, video, image, graphics, and/or electronic data received from any content and/or data source.

The example device 1300 includes a processor system 1308 of one or more processors (e.g., any of microprocessors, controllers, and the like) and/or a processor and memory system implemented as a system-on-chip (SoC) that processes computer-executable instructions. The processor system 1308 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 1310. The example device 1300 may also include any type of a system bus or other data and command transfer system that couples the various components within the device. A system bus can include any one or combination of different bus structures and architectures, as well as control and data lines.

The example device 1300 also includes memory and/or memory devices 1312 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 1312 include volatile memory and non-volatile memory, fixed and removable media devices, and any suitable memory device or electronic data storage that maintains data for computing device access. The memory devices 1312 can include various implementations of random-access memory (RAM), read-only memory (ROM), flash memory, and other types of storage media in various memory device configurations. The example device 1300 may also include a mass storage media device.

The memory devices 1312 (e.g., as computer-readable storage memory) provide data storage mechanisms, such as to store the device data 1304, other types of information and/or electronic data, and various device applications 1314 (e.g., software applications and/or modules). For example, an operating system 1316 may be maintained as software instructions with a memory device 1312 and executed by the processor system 1308 as a software application. The device applications 1314 may also include a device manager, such as any form of a control application, software application, signal-processing and control module, code that is specific to a particular device, a hardware abstraction layer for a particular device, and so on.

In this example, the device 1300 includes a synchronization manager 1318 that implements various aspects of the described features and techniques described herein. The synchronization manager 1318 may be implemented with hardware components and/or in software as one of the device applications 1314, such as when the example device 1300 is implemented as the microphone 108 described with reference to FIGS. 1-12. An example of the synchronization manager 1318 is the Communication network 106 implemented by the microphone 108, such as a software application and/or as hardware components in the mobile device. In implementations, the synchronization manager 1318 may include independent processing, memory, and logic components as a computing and/or electronic device integrated with the example device 1300.

The example device 1300 can also include a microphone 1320 (e.g., to capture an audio recording) and/or camera devices 1322, as well as device sensors 1324, such as may be implemented as components of an inertial measurement unit (IMU). The device sensors 1324 may be implemented with various sensors, such as a gyroscope, an accelerometer, and/or other types of motion sensors to sense motion of the device. The device sensors 1324 can generate sensor data vectors having three-dimensional parameters (e.g., rotational vectors in x, y, and z-axis coordinates) indicating location, position, acceleration, rotational speed, and/or orientation of the device. The example device 1300 can also include one or more power sources 1326, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 1300 can also include an audio and/or video processing system 1328 that generates audio data for an audio system 1330 and/or generates display data for a display system 1332. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 1300. Alternatively, the audio system and/or the display system are external, peripheral components to the example device.

Although implementations for synchronized invocation of an action on multiple devices have been described in language specific to features and/or methods, the appended claims are not necessarily limited to the specific features or methods described. Rather, the specific features and methods are disclosed as example implementations for synchronized invocation of an action on multiple devices, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a mobile device, including: at least one memory, and at least one processor coupled with the at least one memory and configured to cause the mobile device to: detect an additional mobile device that is located within a threshold distance of the mobile device and that satisfies one or more criteria for synchronization of one or more actions with the mobile device, invoke an action and receive consent from the additional mobile device to invoke the action, and send a trigger to invoke the action using the additional mobile device based at least in part on receiving the consent.

In some aspects, the techniques described herein relate to a mobile device, wherein the consent from the additional mobile device is indicated by verbal consent detected from a user of the additional mobile device using voice recognition.

In some aspects, the techniques described herein relate to a mobile device, wherein the threshold distance is determined based on a determined location for the mobile device and a received indication of a location from the additional mobile device.

In some aspects, the techniques described herein relate to a mobile device, wherein the at least one processor is further configured to detect the additional mobile device in response to a trigger involving an application related to a group activity being launched on the mobile device.

In some aspects, the techniques described herein relate to a mobile device, wherein the trigger involves transmitting instruction to the additional mobile device to automatically open a webpage using the additional mobile device that is open on the mobile device.

In some aspects, the techniques described herein relate to a mobile device, wherein the trigger involves automatically launching an application using the additional mobile device that is launched on the mobile device, and the at least one processor is further configured to request information from the additional mobile device indicating whether the application is downloaded on the additional mobile device.

In some aspects, the techniques described herein relate to a mobile device, wherein the at least one processor is further configured to transmit a prompt to the additional mobile device to prompt a user of the additional mobile device to download the application on the additional mobile device based on the information from the additional mobile device indicating whether the application is downloaded on the additional mobile device.

In some aspects, the techniques described herein relate to a mobile device, wherein the at least one processor is further configured to monitor the additional mobile device based on received usage information to determine that content displayed on the mobile device is synchronized with content displayed on the additional mobile device.

In some aspects, the techniques described herein relate to a mobile device, wherein the at least one processor is further configured to transmit a prompt to the additional mobile device to request the consent to invoke the action.

In some aspects, the techniques described herein relate to a method performed by a mobile device, the method including: detecting an additional mobile device that is located within a threshold distance of the mobile device and that satisfies one or more criteria for synchronization of one or more actions with the mobile device, invoking an action and receive consent from the additional mobile device to invoke the action, and sending a trigger to invoke the action using the additional mobile device based at least in part on receiving the consent.

In some aspects, the techniques described herein relate to a method, further including determining that the mobile device and the additional mobile device are located within a threshold distance based on a determined location for the mobile device and a determined location for the additional mobile device.

In some aspects, the techniques described herein relate to a method, wherein the consent from the additional mobile device is indicated by verbal consent detected from a user of the additional mobile device using voice recognition.

In some aspects, the techniques described herein relate to a method, wherein the trigger involves automatically opening a webpage using the additional mobile device that is open on the mobile device.

In some aspects, the techniques described herein relate to a method, wherein the trigger involves automatically launching an application using the additional mobile device that is launched on the mobile device, and further including determining whether the application is downloaded on the additional mobile device.

In some aspects, the techniques described herein relate to a method, further including prompting a user of the additional mobile device to download the application on the additional mobile device based on the determination on whether the application is downloaded on the additional mobile device.

In some aspects, the techniques described herein relate to a method, further including monitoring the mobile device and the additional mobile device to determine that content displayed on the mobile device is synchronized with content displayed on the additional mobile device.

In some aspects, the techniques described herein relate to a system, including: a memory to maintain identities of at least one or more mobile devices for synchronization in an environment, and a synchronization manager configured to: receive an indication of an invocation of an action by a mobile device, detect that an additional mobile device is within a threshold distance of the mobile device and that the additional mobile device is identified in the memory as being pre-associated for synchronization of one or more actions with the mobile device, receive consent from the additional mobile device to invoke an action, and send a trigger to invoke the action using the additional mobile device.

In some aspects, the techniques described herein relate to a system, wherein the synchronization manager is further configured to determine the additional mobile device is within the threshold distance of the mobile device based on received calendar data indicating a user of the mobile device and a user of the additional mobile device attending an event.

In some aspects, the techniques described herein relate to a system, wherein the trigger involves automatically opening a webpage using the additional mobile device that is open on the mobile device.

In some aspects, the techniques described herein relate to a system, wherein the trigger involves automatically launching an application using the additional mobile device that is launched on the mobile device, and the synchronization manager is further configured to prompt a user of the additional mobile device based on received data indicating whether the application is downloaded on the additional mobile device.

1. A mobile device, comprising:
at least one memory; and
at least one processor coupled with the at least one memory and configured to cause the mobile device to:
detect an additional mobile device that is located within a threshold distance of the mobile device and that satisfies one or more criteria for synchronization of one or more actions with the mobile device;
invoke an action and receive consent from the additional mobile device to invoke the action; and
send a trigger to invoke the action using the additional mobile device based at least in part on receiving the consent.

2. The mobile device of claim 1, wherein the consent from the additional mobile device is indicated by verbal consent detected from a user of the additional mobile device using voice recognition.

3. The mobile device of claim 1, wherein the threshold distance is determined based on a determined location for the mobile device and a received indication of a location from the additional mobile device.

4. The mobile device of claim 1, wherein the at least one processor is further configured to detect the additional mobile device in response to a trigger involving an application related to a group activity being launched on the mobile device.

5. The mobile device of claim 1, wherein the trigger involves transmitting instruction to the additional mobile device to automatically open a webpage using the additional mobile device that is open on the mobile device.

6. The mobile device of claim 1, wherein the trigger involves automatically launching an application using the additional mobile device that is launched on the mobile device, and the at least one processor is further configured to request information from the additional mobile device indicating whether the application is downloaded on the additional mobile device.

7. The mobile device of claim 6, wherein the at least one processor is further configured to transmit a prompt to the additional mobile device to prompt a user of the additional mobile device to download the application on the additional mobile device based on the information from the additional mobile device indicating whether the application is downloaded on the additional mobile device.

8. The mobile device of claim 1, wherein the at least one processor is further configured to monitor the additional mobile device based on received usage information to determine that content displayed on the mobile device is synchronized with content displayed on the additional mobile device.

9. The mobile device of claim 1, wherein the at least one processor is further configured to transmit a prompt to the additional mobile device to request the consent to invoke the action.

10. A method performed by a mobile device, the method comprising:
detecting an additional mobile device that is located within a threshold distance of the mobile device and that satisfies one or more criteria for synchronization of one or more actions with the mobile device;
invoking an action and receiving consent from the additional mobile device to invoke the action; and
sending a trigger to invoke the action using the additional mobile device based at least in part on receiving the consent.

11. The method of claim 10, further comprising determining that the mobile device and the additional mobile device are located within a threshold distance based on a determined location for the mobile device and a determined location for the additional mobile device.

12. The method of claim 10, wherein the consent from the additional mobile device is indicated by verbal consent detected from a user of the additional mobile device using voice recognition.

13. The method of claim 10, wherein the trigger involves automatically opening a webpage using the additional mobile device that is open on the mobile device.

14. The method of claim 10, wherein the trigger involves automatically launching an application using the additional mobile device that is launched on the mobile device, and further comprising determining whether the application is downloaded on the additional mobile device.

15. The method of claim 14, further comprising prompting a user of the additional mobile device to download the application on the additional mobile device based on the determination on whether the application is downloaded on the additional mobile device.

16. The method of claim 10, further comprising monitoring the mobile device and the additional mobile device to determine that content displayed on the mobile device is synchronized with content displayed on the additional mobile device.

17. A system, comprising:
a memory to maintain identities of at least one or more mobile devices for synchronization in an environment; and
a synchronization manager configured to:
receive an indication of an invocation of an action by a mobile device;
detect that an additional mobile device is within a threshold distance of the mobile device and that the additional mobile device is identified in the memory as being pre-associated for synchronization of one or more actions with the mobile device;
receive consent from the additional mobile device to invoke the action; and
send a trigger to invoke the action using the additional mobile device.

18. The system of claim 17, wherein the synchronization manager is further configured to determine the additional mobile device is within the threshold distance of the mobile device based on received calendar data indicating a user of the mobile device and a user of the additional mobile device attending an event.

19. The system of claim 17, wherein the trigger involves automatically opening a webpage using the additional mobile device that is open on the mobile device.

20. The system of claim 17, wherein the trigger involves automatically launching an application using the additional mobile device that is launched on the mobile device, and the synchronization manager is further configured to prompt a user of the additional mobile device based on received data indicating whether the application is downloaded on the additional mobile device.
